(19) United States
(12) Patent Application Publication
(10) Pub. No.: US 2018/0342117 A1
(43) Pub. Date: Nov. 29, 2018

(54) ELECTRONIC CONTROL UNIT

(71) Applicant: DENSO CORPORATION, Kariya-city (JP)

(72) Inventor: Daisuke SUZUKI, Kariya-city (JP)

(21) Appl. No.: 15/980,990

(22) Filed: May 16, 2018

(30) Foreign Application Priority Data
May 25, 2017 (JP) 2017-103929

(51) Int. Cl. G07C 5/08; F02D 41/14; B60H 1/00

(52) U.S. Cl. CPC G07C 5/0808; F02D 41/1441; F02D 2200/0418; B60H 1/00978; F02D 41/14

(57) ABSTRACT

An electronic control unit (ECU) obtains an outside air humidity from an outside air humidity sensor disposed outside a vehicle compartment and an inside air humidity from an inside air humidity sensor disposed inside the vehicle compartment. The ECU includes a humidity obtainer obtaining the inside air humidity and the outside air humidity, and a humidity difference calculator calculating a humidity difference between (i) the inside air humidity after a preset amount of humidity adjustment time from a start of a dehumidification inside the vehicle compartment and (ii) the outside air humidity. The ECU then determines that either the outside air humidity sensor or the inside air humidity sensor is broken when the humidity difference is greater than a first threshold, thereby detecting a failure of the humidity sensor during a travel of a vehicle.

### CROSS REFERENCE TO RELATED APPLICATION

The present application is based on and claims the benefit of priority of Japanese Patent Application No. 2017-103929, filed on May 25, 2017, the disclosure of which is incorporated herein by reference.

### TECHNICAL FIELD

The present disclosure generally relates to an electronic control unit for controlling a humidity sensor.

### BACKGROUND INFORMATION

An electronic control unit used in a vehicle for controlling an internal-combustion engine typically obtains physical quantities from an environment in which the vehicle travels, for a control of a drive of the internal-combustion engine. Humidity is one of such quantities. Since the internal-combustion engine mixes outside air taken in from the surrounding environment and fuel for the combustion, the electronic control unit needs to control the combustion based on the humidity of the outside air for an appropriate drive of the engine. Further, the electronic control unit also needs to refer to inside air humidity, i.e., humidity in a vehicle compartment, for controlling a degree of dehumidification performed by an evaporator when cooling the vehicle compartment by an air-conditioning device. Note that a vehicle compartment may also be designated as a passenger compartment in the following.

As described above, the electronic control unit obtains humidity information from an outside air humidity sensor and from an inside air humidity sensor respectively disposed outside and inside of the vehicle, for controlling a drive of the internal-combustion engine and/or the evaporator. Therefore, failure of the humidity sensor may deteriorate the comfort in the vehicle, e.g., driver's comfort during the driving of the vehicle. In view of such a situation, various methods are proposed for detecting the failure of the humidity sensor. For example, a failure detection method for detecting the failure of the humidity sensor disclosed in a patent document 1, U.S. Pat. No. 7,654,253, is a method that detects the failure or degradation of the humidity sensor disposed outside of the vehicle, i.e., outside of the vehicle compartment, more practically. In such method, humidity obtained from the humidity sensor disposed outside of the vehicle compartment is compared with humidity obtained from the humidity sensor inside the vehicle compartment after a lapse of preset soak time after the switching OFF of an ignition switch, and, based on a difference between two humidity values being greater than a preset value, it is determined that the function of the humidity sensor has degraded.

Now, in an actual operation situation of the humidifier and the humidity detector, the humidity value detected by the humidity sensor in a traveling vehicle (i.e., inside air humidity) is usually different from the humidity of the outside air (i.e., outside air humidity). Regarding diagnosis of the inside humidity sensor and the outside humidity sensor, the diagnosis method disclosed in the patent document 1 works properly/appropriately only when a sufficient amount of equilibrating time for equilibrating the humidity value from the outside air humidity sensor and the humidity value from the inside air humidity sensor is taken. In other words, the diagnosis of the outside/inside air humidity sensor is performable only when the ignition switch of the vehicle is turned OFF.

### SUMMARY

It is an object of the present disclosure to provide an electronic control unit that is capable of performing a failure detection operation for detecting a failure of the humidity sensor during a travel of a vehicle (i.e., during operation of the vehicle).

In an aspect of the present disclosure, the electronic control unit (ECU) that obtains an outside air humidity detected by an outside air humidity sensor disposed at a position outside a vehicle compartment of a vehicle and an inside air humidity detected by an inside air humidity sensor disposed at a position inside the vehicle compartment, includes: a humidity obtainer obtaining the inside air humidity and the outside air humidity; a humidity difference calculator calculating a humidity difference between (i) the inside air humidity after a preset amount of humidity adjustment time from a start of a dehumidification inside the vehicle compartment and (ii) the outside air humidity; and a comparator determining that either the outside air humidity sensor or the inside air humidity sensor is broken when the humidity difference is greater than a first threshold.

After the lapse of a preset amount of time (i.e., after the lapse of the humidity adjustment time) from the start of dehumidification, the humidity difference (i.e., ϕ−ρ) still remaining to be greater than the first threshold means that, even though dehumidification has been performed, the humidity of the outside air detected by the outside air humidity sensor is lower than the humidity of the inside air (i.e., the humidity inside the vehicle compartment). Usually, such a situation will not happen or be observable, thereby strongly suggesting the failure of either of the outside air humidity sensor or the inside air humidity sensor. That is, the electronic control unit has a good reason to determine that the outside air humidity sensor or the inside air humidity sensor is broken and has failed. Such a determination regarding the failure of the humidity sensor is performable during dehumidification, i.e., during a travel of the vehicle. Therefore, there is no need to reserve a preset soak time after turning OFF of the ignition switch, which is conventionally required.

Note that, in addition to the above, when the normal operation of the inside air humidity sensor is confirmed, the electronic control unit can determine that the outside air humidity sensor is broken and has failed.

In another aspect of the present disclosure, the electronic control unit (ECU) that obtains an outside air humidity detected by an outside air humidity sensor disposed at a position outside a vehicle compartment of a vehicle and an inside air humidity detected by an inside air humidity sensor disposed at a position inside the vehicle compartment, includes: a humidity obtainer obtaining the inside air humidity and the outside air humidity; a humidity difference calculator calculating a humidity difference between (i) the inside air humidity after a preset amount of humidity adjustment time from a start of a humidification inside the vehicle compartment and (ii) the outside air humidity; and a comparator determining that either the outside air humidity sensor or the inside air humidity sensor is broken when the humidity difference is smaller than a second threshold.

After the lapse of a preset amount of time (i.e., after the lapse of the humidity adjustment time) from the start of humidification, the humidity difference (i.e., ϕ−ρ) still remaining to be smaller than the second threshold means that, even though humidification has been performed, the humidity of the outside air detected by the outside air humidity sensor is higher than the humidity of the inside air (i.e., the humidity inside the vehicle compartment). Usually, such a situation will not happen or be observable, thereby strongly suggesting the failure of either of the outside air humidity sensor or the inside air humidity sensor. That is, the electronic control unit has a good reason to determine that the outside air humidity sensor or the inside air humidity sensor is broken and has failed. Such a determination regarding the failure of the humidity sensor is performable during humidification, i.e., during a travel of the vehicle. Therefore, there is no need to reserve a preset soak time after turning OFF of the ignition switch, which is conventionally required.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of configuration of an engine control system in a first embodiment of the present disclosure;

FIG. 2 is a block diagram of configuration of an electronic control unit;

FIG. 3 is a time chart of change of relative humidity;

FIG. 4 is a flowchart of an operation of the electronic control unit; and

FIG. 5 is an OK-NG graph of a diagnosis result of an outside air humidity sensor; and

FIG. 6 is a flowchart of an operation of the electronic control unit in a modification example.

### DETAILED DESCRIPTION

In the following description, a plurality of embodiments of the present disclosure are described, with reference to the drawings. In the plurality of embodiments, like parts have like numbers, and the description of the like parts may be not repeated. The configuration of one embodiment in part or as a whole may be combined with other embodiment(s), unless otherwise indicated. A possibility of combination of two or more embodiments may be explicitly described, or may only be suggested or may be not mentioned.

### First Embodiment

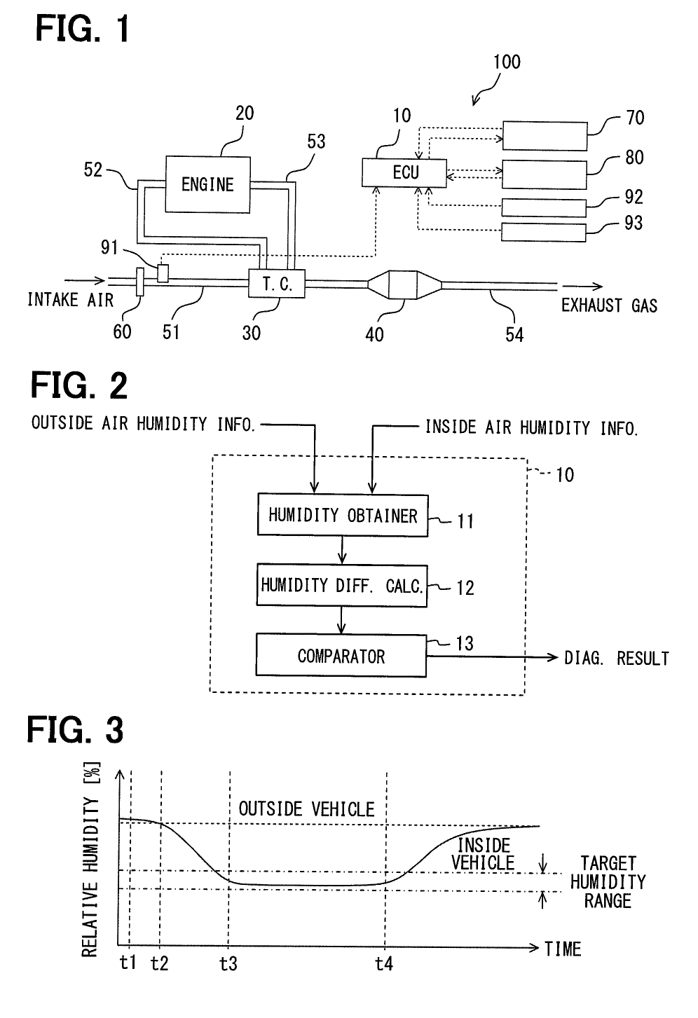

The first embodiment of the present disclosure, including the outline configuration of an electronic control unit concerning the present embodiment is described with reference to FIGS. 1 and 2.

The electronic control unit in the present embodiment is an electronic device which controls an internal-combustion engine in a vehicle such as, for example, an engine control ECU. This electronic control unit performs control of an internal-combustion engine and an air-conditioner based on the information on humidity, which may be derived from communication with the humidity sensors disposed outside and inside of a vehicle compartment. That is, the ECU and the humidity sensors are communicably connected. Further, the ECU performs control concerning diagnosis of the humidity sensor.

As shown in FIG. 1, an electronic control unit 10 constitutes a part of an engine control system 100. That is, the engine control system 100 is provided with the electronic control unit 10, an engine 20, a turbocharger 30, and the post-process apparatus 40. In addition, the engine control system 100 is provided with a first suction passage 51 which introduces the outside air into the turbocharger 30, a second suction passage 52 which sends an intake air from the turbocharger 30 to the engine 20, a first exhaust passage 53 which introduces an exhaust gas of the engine 20 into the turbocharger 30, and a second exhaust passage 54 which discharges the exhaust gas from the turbocharger 30. An air cleaner 60 is installed in the first suction passage 51.

The engine control system 100 is further provided with an air-conditioner system 70, an air circulation system 80, and various sensors 91, 92, and 93. Various sensors are, for example, an outside air humidity sensor 91, an inside air humidity sensor 92, and an in-vehicle temperature sensor 93. The air-conditioner system 70, the air circulation system 80, and the various sensors 91, 92, and 93 are respectively communicably connected with the electronic control unit 10.

First, elements and components other than the electronic control unit 10 are described.

The engine 20 is a mechanism for transferring power to wheels in a vehicle and driving the vehicle. The engine 20 in the present embodiment is the one that takes the outside air, mixes the air with fuel, and burns the mixture, for example, which may be a gasoline engine and/or a diesel engine. The axial output generated by the engine 20 determines its torque and the number of rotations, and contributes to the charging of the battery. Further, thermal power generated by the engine 20 contributes to heating energy, e.g., to heat the vehicle compartment. The engine 20 is connected to the turbocharger 30 via the second suction pass 52, for taking in the outside air. On the other hand, the exhaust gas of the engine 20 is discharged to the turbocharger 30 via the first exhaust pass 53, is detoxified/scrubbed by the post-process apparatus 40, and is discharged toward outside of the vehicle.

The turbocharger 30 is a supercharger which compresses the intake air to supply a high-density air to the engine 20. The turbocharger 30 is connected to the engine 20 with the second suction pass 52 and the first exhaust pass 53. The turbocharger 30 has a turbine rotated by the exhaust gas from the engine 20, and a compressor compressing the intake air by the rotation of the turbine. After the outside air taken in from the first suction pass 51 connected to the turbocharger 30 is compressed by the turbocharger 30, it is supplied to the engine 20.

The post-process apparatus 40 is a device which is disposed in the second exhaust pass 54 at a downstream position than the turbocharger 30, and detoxifies the exhaust gas of the engine 20. In the post-process apparatus 40, a particulate filter which captures and removes particulates in the exhaust gas is provided, for example. The particulate filter may have a mechanism in which an oxidation catalyst is used for removing a hydrocarbon component. The post-process apparatus 40 may also include a NOx catalyst. Such catalyst decomposes and removes the nitrogen oxide in the exhaust gas. The NOx catalyst may use a reduction method, such as a urea selection reduction method and an occlusion reduction method, for efficient decomposition.

The air cleaner 60 is disposed in the first suction pass 51, and filters/removes sand, dust, moisture, etc. contained in the outside air. By using the air cleaner 60, intrusion of foreign substance into the turbocharger 30 or into the engine 20 is prevented.

The air-conditioner system 70 is a system for conditioning air, and has, especially for cooling, a dehumidifying function including an evaporator. The air-conditioner system 70 performs cooling and dehumidification in the passenger/vehicle compartment according to a user's operation or according to an instruction from the electronic control unit 10.

The air-conditioner system 70 has a system which takes in air from a passenger compartment, for example, and performs decompression cooling by the evaporator, and the water vapor condensed by such cooling to reach a dew point changes its state from gas to liquid, i.e., to water, and is discharged to the outside of the vehicle. In such manner, dehumidification of the passenger compartment is performed. Therefore, when the air-conditioner system 70 is working as a dehumidifier system, humidity of the air after passing the evaporator is lower than humidity of the air before passing the evaporator.

The air circulation system 80 is a system that chooses either an outside air introduction mode or an inside air recirculation mode for circulation of air in the passenger compartment. Although the choice of one of two modes is basically performed by the user's operation, the two modes are also switchable according to a situation by the electronic control unit 10 in the present embodiment.

Here, the outside air introduction mode is an operation mode which takes in the outside air (i.e., air from outside of the vehicle) regarding how the air is “circulated” in the passenger compartment, in which direct communication between the outside and the inside of the vehicle is established. That is, in the outside air introduction mode, time to achieve an equilibrium state between the outside and the inside of the vehicle (i.e., “time to in-out balance”) is reduced. On the other hand, the inside air recirculation mode is an operation mode which does not take in the outside air for the air circulation, i.e., which simply circulates air in the passenger compartment, in which the air inside of the passenger compartment and the air outside of the passenger compartment are kept separated. In the inside air recirculation mode, since positive air exchange with the outside is not performed, time to in-out balance for the outside and the inside of the passenger compartment becomes long compared with the outside air introduction mode. Note that, even in the inside air recirculation mode, since the inside of the passenger compartment is not tightly sealed from the outside, the air is exchanged therebetween through a gap between a door and a body, for example.

The outside air humidity sensor 91 is a sensor attached to an air flow meter that is disposed at a downstream position of the air cleaner 60. That is, the outside air humidity sensor 91 detects humidity of air immediately after the air is taken into the first suction passage 51, and an outside air humidity detected by the outside air humidity sensor 91 reflects humidity information of the outside air. Note that, in the present embodiment, the outside air humidity which is detected and provided by the outside air humidity sensor 91 is relative humidity of the outside air. The electronic control unit 10 in the present embodiment performs processing for failure detection of the outside air humidity sensor 91.

The inside air humidity sensor 92 is a sensor disposed in the passenger compartment. Inside air humidity information detected by the inside air humidity sensor 92 reflects humidity of the air in the passenger compartment. Note that, in the present embodiment, the inside air humidity which is detected and provided by the inside air humidity sensor 92 is relative humidity of the inside air, i.e., humidity of the air in the passenger compartment. The electronic control unit 10 in the present embodiment performs failure detection of the outside air humidity sensor 91 based on an assumption that the inside air humidity sensor 92 is operating normally/correctly. The diagnosis of the inside air humidity sensor 92 may be performed as an electric conductivity check or the like, for example.

The in-vehicle temperature sensor 93 is a temperature sensor which is disposed in the passenger compartment and detects temperature in the passenger compartment. The in-vehicle temperature sensor 93 is connected with the electronic control unit 10, and the in-vehicle temperature sensor 93 provides the information on temperature in the passenger compartment.

The electronic control unit 10 controls the drive of the engine 20 based on the outside air humidity obtained by the outside air humidity sensor 91, and controls the air-conditioner system 70 based on the inside air humidity in the passenger compartment obtained by the inside air humidity sensor 92 and temperature in the passenger compartment.

Next, the electronic control unit 10 is described in detail.

As shown in FIG. 2, the electronic control unit 10 is provided with a humidity obtainer 11, a humidity difference calculator 12, and a comparator 13.

The outside air humidity is input to the humidity obtainer 11 from the outside air humidity sensor 91. The inside air humidity is input thereto from the inside air humidity sensor 92. The outside air humidity and the inside air humidity in the present embodiment are relative humidity, i.e., a ratio of the vapor content (i.e., vapor pressure) of the actual air to the amount of saturated aqueous vapor at a preset temperature (i.e., saturation vapor pressure). Further, information on temperature of the passenger compartment is also input from the in-vehicle temperature sensor 93 to the humidity obtainer 11, thereby enabling the humidity obtainer 11 to convert the detected relative humidity into physical quantity, such as absolute humidity (e.g., weight absolute humidity, specific humidity, etc.) and/or air density, based on databases, such as a psychrometric chart stored in the memory which is not illustrated. In case of conversion of the relative humidity to the physical quantity, another physical quantity, such as atmospheric pressure and specific enthalpy, which may be obtained by a not-illustrated sensor or which may be estimated, is referred to in addition to the input of the temperature information of the passenger compartment.

The humidity difference calculator 12 is a section which calculates the difference between an inside air humidity ϕ and an outside air humidity ρ at the predetermined time. The humidity calculation part 12 in the present embodiment calculates the difference between the inside air humidity ϕ and the outside air humidity ρ after the lapse of preset humidity adjustment time from a turning ON time of an ignition switch, i.e., from a start of dehumidification. The comparator 13 is a section which compares the difference between the inside air humidity ϕ and the outside air humidity ρ with a predetermined threshold. In the present embodiment, a first threshold P1 and a second threshold P2 are set respectively as a predetermined threshold. P1 is a positive number including zero. P2 is a negative number including zero. Further, based on the comparison result, a diagnosis result is output toward outside, i.e., to an external device. The diagnosis result is a possibility of whether the outside air humidity sensor 91 or the inside air humidity sensor 92 has a failure. That is, the comparator 13 of the electronic control unit 10 determines that either the outside air humidity sensor 91 or the inside air humidity sensor 92 is broken by comparing the humidity difference to a threshold, e.g., the first threshold P1, the second threshold P2.

Note that, as for the comparator 13 in the present embodiment, while it is determining whether ϕ−ρ>P1, i.e., determining whether (ϕ−ρ>P1) is true or false, the comparator 13 also determines whether (ϕ−ρ<P2) is true or false. For example, when the first threshold P1 is set as zero and the second threshold P2 is set as zero, the comparator 13 determines whether (ϕ−ρ<0) is true or false while determining whether (ϕ−ρ>0) is true or false.

If (ϕ−ρ>0) is true under a condition of performing the dehumidification in the passenger compartment, it means that (ϕ>ρ). This is an “unlikely” situation in which the inside air humidity ϕ is higher than the outside air humidity ρ even after performing dehumidification in the passenger compartment, i.e., it is an unusual situation. Therefore, based on such a situation, the comparator 13 of the electronic control unit 10 outputs a diagnosis result indicating that the outside air humidity sensor 91 is possibly failing. The comparator 13 of the electronic control unit 10 may also output a diagnosis result indicating that the inside air humidity sensor 92 is possibly failing.

On the other hand, if (ϕ−ρ<0) is true under a condition of performing humidification in the passenger compartment, it means that (ϕ<ρ). This is also an “unlikely” situation in which the inside air humidity ϕ is lower than the outside air humidity ρ even after performing humidification in the passenger compartment, i.e., it is also an unusual situation. Therefore, based on such a situation, the comparator 13 of the electronic control unit 10 outputs a diagnosis result indicating that the outside air humidity sensor 91 is possibly failing. The comparator 13 of the electronic control unit 10 may also output a diagnosis result indicating that the inside air humidity sensor 92 is possibly failing.

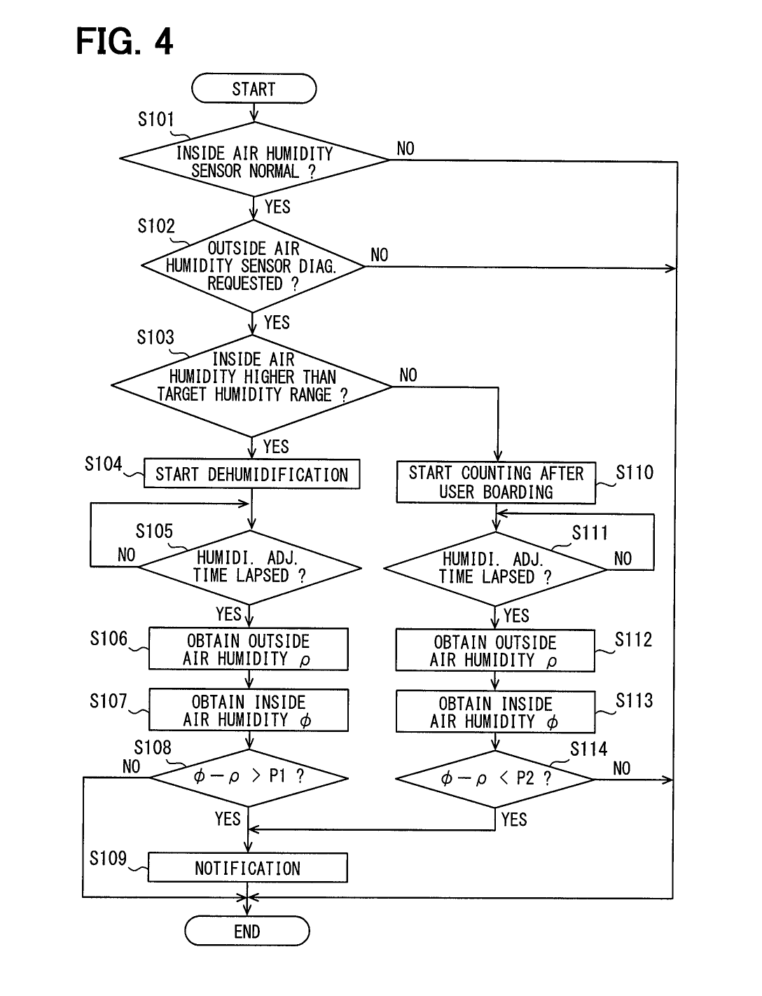

Next, with reference to FIGS. 3 and 4, a concrete operation of the electronic control unit 10 in the present embodiment is described.

A situation shown in FIG. 3 is used as an assumption. That is, an ignition switch is turned ON at time t1, the air-conditioner system 70 starts almost simultaneously at time t1, thereby dehumidification is started. Henceforth, the humidity in the passenger compartment starts to fall at time t2, and when a target humidity range is reached at time t3, such humidity state is maintained thereafter. Then, at time t4, the ignition switch is turned OFF, and dehumidification by the air-conditioner system 70 stops almost simultaneously at time t4. The relative humidity in the passenger compartment gradually increases by the exchange of the inside air with the outside air.

An operation of the electronic control unit 10 concerning the diagnosis of the outside air humidity sensor 91 and inside air humidity sensor 92 is described with reference to an operation flow shown in FIG. 4.

First, Step S101 is performed. In Step S101, diagnosis of the inside air humidity sensor 92 is performed, and it is determined and confirmed that the inside air humidity sensor 92 is operating normally. This diagnosis may be a confirmation about whether there is a disconnection of wiring or the like in the sensor 92 by supplying an electric power to the sensor 92. When it is confirmed that the inside air humidity sensor 92 is operating normally, Step S101 branches to a YES determination. On the other hand, when the inside air humidity sensor 92 is out of order, i.e., may possibly be broken, Step S101 branches to a NO determination, and the diagnosis operation of the outside air humidity sensor 91 is ended.

When Step S101 is a YES determination, Step S102 is performed. Step S102 is a step which determines whether a diagnosis request of the outside air humidity sensor 91 is given to the electronic control unit 10. If a diagnosis of the outside air humidity sensor 91 is requested, Step S102 branches to a YES determination, and, if not requested, Step S102 branches to a NO determination and an operation flow ends itself.

When Step S102 is a YES determination, Step S103 is performed. Step S103 is a step which determines whether the relative humidity detected by the inside air humidity sensor 92 as the humidity in the passenger compartment is higher than the target humidity range of the passenger compartment. S103 branches to a YES determination when the relative humidity in the passenger compartment is higher than the target humidity range. In such a case, a dehumidifier system is driven and the dehumidification of the passenger compartment is performed.

On the other hand, S103 branches to a NO determination when the relative humidity in the passenger compartment is lower than the target humidity range. In such case, if a humidifier is provided in the passenger compartment, the humidifier is driven for performing the humidification of the passenger compartment, or the humidification is otherwise performed by a user's perspiration, respiration, etc.

As described in FIG. 3, when it is assumed that the dehumidification is performed for decreasing the humidity in the passenger compartment (i.e., the dehumidification is started in a state that the inside air humidity is higher than the target humidity range), Step S103 branches to a YES determination, and Step S104 is performed. Step S104 is a step which starts the dehumidification in the passenger compartment. More practically, the air-conditioner system 70 is driven and the dehumidification is performed by the evaporator.

Subsequently, Step S105 is performed. Step S105 is a step which determines whether a preset humidity adjustment time has lapsed from a dehumidification start timing. Here, a preset humidity adjustment time is a certain period of time or a duration after which an effect of the dehumidification shows up in the passenger compartment, which may be, for example, a period of time from time t1 to time t2 shown in FIG. 3. That is, the humidity adjustment time is a period of time being equal to or greater than t2−t1. The humidity adjustment time may be set as a time from t1 to t3, at which (i.e., at time t3) the humidity stabilizes in the target humidity range. The humidity adjustment time may also be set as a duration/length somewhere between t2−t1 and t3−t1. During a time before the lapse of the preset humidity adjustment time, Step S105 branches to a NO determination, and Step S105 is repeatedly performed. After the lapse of the preset humidity adjustment time from the start of the dehumidification, Step S105 branches to a YES determination, and the process proceeds to Step S106.

Step S106 is a step which obtains the relative humidity ρ of the outside air after the lapse of the humidity adjustment time. The information on the outside air humidity detected by the outside air humidity sensor 91 is temporarily stored by the humidity obtainer 11.

Subsequently, Step S107 is performed. Step S107 is a step which obtains the inside air relative humidity ϕ after the lapse of the humidity adjustment time. The information on the inside air humidity detected by the inside air humidity sensor 92 is temporarily stored by the humidity obtainer 11.

Subsequently, Step S108 is performed. Step S108 is a step in which the humidity difference calculator 12 calculates the difference ϕ−ρ based on the inside air humidity ϕ and the outside air humidity ρ obtained in the above, and the comparator 13 compares a calculated difference ϕ−ρ and the first predetermined threshold P1. Specifically, as for the comparator 13, it determines whether (ϕ−ρ>P1) is true or false. When (ϕ−ρ>P1) is true, Step S108 branches to a YES determination. As discussed in the above, it is usually an “unlikely” situation that the inside air humidity ϕ is higher than the outside air humidity ρ under a condition of performing the dehumidification of the inside of the passenger compartment for a certain period of time, thereby the comparator 13 of the electronic control unit 10 determines, i.e., has a good reason to determine in view of such a situation, that either the outside air humidity sensor 91 or the inside air humidity sensor 92 may possibly be broken and/or failing. That is, in Step S109, the possibility of failure of the sensor 91 or the sensor 92 is notified to the user.

On the other hand, if Step S108 is a NO determination, the outside air humidity sensor 91 or the inside air humidity sensor 92 has a high possibility of operating normally, and an operation flow is ended, without performing notification to the user.

Regarding the in-equation discussed above, when the first threshold P1 is zero, Step S108 is a comparison of magnitude between the inside air humidity ϕ and the outside air humidity p. On the other hand, since it is naturally expected that signal noise and/or a measurement error affects the inside air humidity ϕ and the outside air humidity ρ, respectively, these factors may be added to the first threshold P1. That is, for example, based on a measurement error δϕ of the inside air humidity and a measurement error δρ of the outside air humidity, the first threshold P1 may be calculated as P1=[(δϕ)²+(δρ)²]^{1/2}.

Note that the above calculation is described as an example of undergoing Step S104, based on an assumption that the inside air humidity is higher than the target humidity range before the start of the dehumidification as shown in FIG. 3. On the other hand, if the situation is assumed that the inside air humidity ϕ is lower than the target humidity range, Step S103 branches to a NO determination, and, as shown in FIG. 4, the process proceeds to Step S110.

Step S110 is a step in which the electronic control unit 10 starts the count of time from a user boarding onto the vehicle. More practically, it may use the turning ON of the ignition switch by the user or may use the detection of user seating on a seat in the vehicle as a trigger to start such counting of time. In the present embodiment, the engine control system 100 is assumed as not having a humidifier for positively performing the humidification. That is, in the present embodiment, the user respiration, perspiration, etc. is the source of the humidification in the passenger compartment.

Subsequently, Step S111 is performed. Step S111 is a step which determines whether the preset humidity adjustment time has lapsed, after the start of the humidification by respiration, i.e., after a user boarding onto the vehicle. Here, the preset humidity adjustment time is a certain period of time or a duration after which an effect of humidification shows up in the passenger compartment. Step S111 branches to a NO determination and Step S111 is repeatedly performed during a time until the lapse of the preset humidity adjustment time after the start of humidification. After the lapse of the preset humidity adjustment time from the start of humidification, Step S111 branches to a YES determination, and the process proceeds to Step S112.

Step S112 is a step which obtains the relative humidity ρ of the outside air after the lapse of the humidity adjustment time. The information on the outside air humidity detected by the outside air humidity sensor 91 is temporarily stored by the humidity obtainer 11.

Subsequently, Step S113 is performed. Step S113 is a step which obtains the inside air relative humidity ϕ after the lapse of the humidity adjustment time. The information on the inside air humidity detected by the inside air humidity sensor 92 is temporarily stored by the humidity obtainer 11.

Subsequently, Step S114 is performed. Step S114 is a step in which the humidity difference calculator 12 calculates the difference ϕ−ρ based on the inside air humidity ϕ and the outside air humidity ρ obtained in the above, and the comparator 13 compares the calculated difference ϕ−ρ and the second predetermined threshold P2. Specifically, as for the comparator 13, it determines whether ϕ−ρ<P2) is true or false. When (ϕ−ρ<P2) is true, Step S114 branches to a YES determination. As discussed above, it is usually in an “unlikely” situation that the inside air humidity ϕ is lower than the outside air humidity ρ under a condition of performing humidification of the inside of the passenger compartment for a certain period of time, thereby the electronic control unit 10 determines, i.e., has a good reason to determine in view of such situation, that either the outside air humidity sensor 91 or the inside air humidity sensor 92 may possibly be broken and/or failing. That is, in Step S109, the possibility of failure of the sensors 91 or 92 is notified to the user.

On the other hand, if Step S114 is a NO determination, either the outside air humidity sensor 91 or the inside air humidity sensor 92 has a high possibility of operating normally, and an operation flow will be ended, without performing notification to the user.

Regarding the in-equation discussed above, when the second threshold P2 is zero, Step S114 is a comparison of magnitude between the inside air humidity ϕ and the outside air humidity ρ. On the other hand, since it is naturally expected that signal noise and/or a measurement error affects the inside air humidity ϕ and the outside air humidity ρ, respectively, these factors may be added to the second threshold P2. That is, for example, based on the measurement error δϕ of the inside air humidity and the measurement error δρ of the outside air humidity, the second threshold P2 may be calculated as P2=−[(δϕ)²+(δρ)²]^{1/2}.

The above is an operation flow of the electronic control unit 10 in the present embodiment.

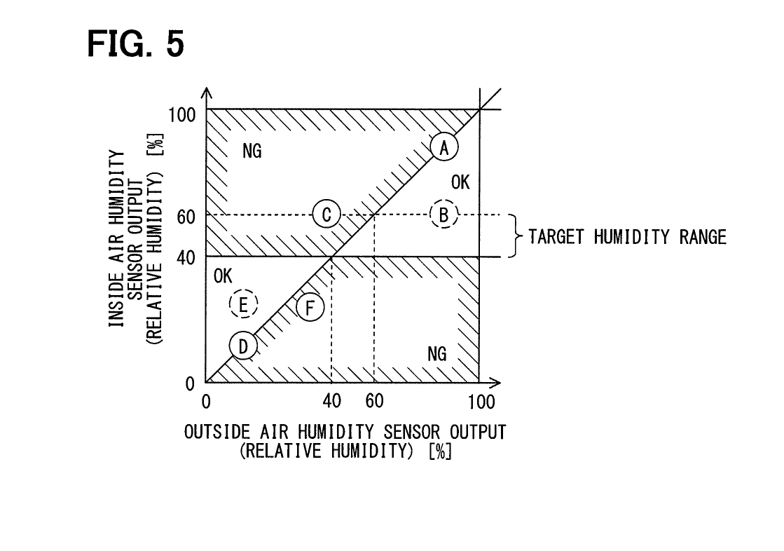

Next, the operation effect of the electronic control unit 10 in the present embodiment is described with reference to FIG. 5.

As described above, the electronic control unit 10 determines that abnormalities have occurred in in the outside air humidity sensor 91 or the inside air humidity sensor 92 when there is a discrepancy between an expected difference of inside-outside humidity and the actual-detected humidity under a condition of performing the dehumidification or the humidification in the passenger compartment, for example. Specifically, when it is already clear and confirmed by another diagnosis processing etc. that the inside air humidity sensor 92 is normal, the abnormalities of the humidity sensor are attributable to the outside air humidity sensor 91, and vice versa.

With reference to FIG. 5, the situation is described more concretely. FIG. 5 is a graph showing an NG area of the outside air humidity sensor 91 when both of the first threshold P1 and the second threshold P2 described above are set to zero, for the ease of understanding.

For example, it is assumed that the outside air humidity sensor 91 and the inside air humidity sensor 92 are both indicating a relative humidity of about 90% before dehumidification (i.e., a point A in FIG. 5). Since a relative humidity of 90% is higher than the target humidity range, it is a situation in which the inside of the passenger compartment should be dehumidified. Supposing that a measurement value of the outside air humidity sensor 91 shows no change, while a measurement value of the inside air humidity sensor 92 has changed to 60% (i.e., a point B in FIG. 5), for example, after the dehumidification is started by driving the air-conditioner system 70 and the preset humidity adjustment time has lapsed. Such a “change” is a normal “change”, thereby Step S108 branches to a NO determination, and the possibility of failure of the outside air humidity sensor 91 is denied. On the other hand, after the dehumidification is started and the preset humidity adjustment time has lapsed, a measurement value of the outside air humidity sensor 91 may show a relative humidity of 40% and a measurement value of the inside air humidity sensor 92 may show a relative humidity of 60% (i.e., a point C in FIG. 5), for example. Such a situation is impossible after performing the dehumidification, thereby Step S108 branches to a YES determination, and the possibility of failure of either the outside air humidity sensor 91 or the inside air humidity sensor 92 is affirmed. That is, the possibility of failure of either the outside air humidity sensor 91 or the inside air humidity sensor 92 is notified to the user, as a result of such determination.

In addition, this diagnosis operation can be performed during the dehumidification, namely, during a travel of the vehicle. Thus, if the electronic control unit 10 of the present embodiment is adopted, failure detection of a humidity sensor can be performed during a travel of the vehicle.

The same applies to a humidification operation. For example, it may be assumed that the outside air humidity sensor 91 and the inside air humidity sensor 92 are both indicating a relative humidity of about 10% before humidification (i.e., a point D in FIG. 5). Since a relative humidity of 10% is lower than the target humidity range, it is a situation in which the passenger compartment is humidified by the respiration or should be positively humidified. Supposing that, after the humidification is started by a user's exhalation and the preset humidity adjustment time has lapsed, a measurement value of the outside air humidity sensor 91 shows no change, while a measurement value of the inside air humidity sensor 92 changes to a relative humidity of about 30% (i.e., a point E in FIG. 5), for example. This is a normal change, thereby Step S114 branches to a NO determination, and the possibility of failure of the outside air humidity sensor 91 is denied. On the other hand, after the humidification is started and the preset humidity adjustment time has lapsed, a measurement value of the outside air humidity sensor 91 may show a relative humidity of about 35% and a measurement value of the inside air humidity sensor 92 may show a relative humidity of about 30% (i.e., a point F in FIG. 5), for example. This is an “unlikely” situation after performing the humidification, thereby Step S114 branches to a YES determination, and the possibility of failure of either the outside air humidity sensor 91 or the inside air humidity sensor 92 is affirmed. That is, the possibility of failure of either the outside air humidity sensor 91 or the inside air humidity sensor 92 is notified to the user.

Just like the case of the dehumidification, this diagnosis operation can be performed during the humidification, namely, it can be performed during a travel of the vehicle. Thus, if the electronic control unit 10 of the present embodiment is adopted, failure detection of a humidity sensor can be performed during a travel of the vehicle.

### Modification

Although the humidity adjustment time reserved from the start of the dehumidification or humidification before performing the diagnosis may be a fixed value set in advance, it may also be set as variable. The humidity adjustment time in the modification is described as a value that is set according to the air circulation mode which is set by the air circulation system 80.

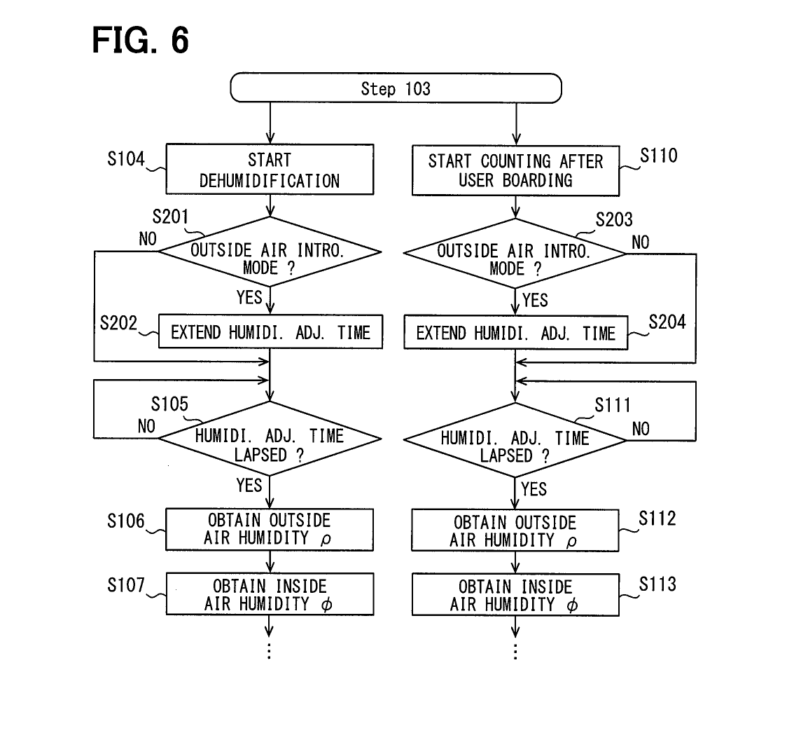

For example, in the electronic control unit 10 of this modification, it is assumed that a default value of the humidity adjustment time is defined under the condition of the inside air recirculation mode. As the operation flow of the electronic control unit 10 in this modification, Steps S201, S202, S203, and S204 of FIG. 6 are added to the operation flow of the first embodiment shown in FIG. 4.

More specifically, after the start of dehumidification in Step S104, Step S201 is performed. Step S201 is a step in which the electronic control unit 10 accesses the air circulation system 80, and checks/confirms the present circulation mode. Here, when the circulation mode is the outside air introduction mode, Step S201 branches to a YES determination, and the process proceeds to Step S202.

Step S202 is a step which extends the humidity adjustment time. That is, the electronic control unit 10 operates to extend the humidity adjustment time that is set up based on the inside air recirculation mode by a preset amount of time, thereby sets a new humidity adjustment time.

On the other hand, when the circulation mode is the inside air recirculation mode in Step S201, the process proceeds to Step S105, without extending the humidity adjustment time.

Note that, even when the operation flow takes a path to go through Step S110, the above-described extension applies in the same manner. More specifically, after the user boarding in Step S110 (i.e., after the start of the humidification), Step S203 is performed. Step S203 is a step in which the electronic control unit 10 accesses the air circulation system 80, and confirms the present circulation mode. Here, when the circulation mode is the outside air introduction mode, Step S203 branches to a YES determination, and the process proceeds to Step S204.

Step S204 is a step which extends the humidity adjustment time. That is, the electronic control unit 10 operates to extend the humidity adjustment time based on the inside air recirculation mode by a preset amount of time, and the extended time is set as a new humidity adjustment time.

On the other hand, when the circulation mode is the inside air recirculation mode in Step S203, the process proceeds to Step S111, without extending the humidity adjustment time.

Thus, in the electronic control unit 10 in this modification, the humidity adjustment time is set as variable based on the circulation mode, i.e., how the air is circulated inside and outside of the passenger compartment. When the circulation mode is the outside air introduction mode, it requires more (i.e., longer) time than the inside air recirculation mode to “meaningfully” differ the humidity in the passenger compartment from the humidity of the outside air, thereby a longer humidity adjustment time is set for performing the diagnosis of the outside air humidity sensor 91 and the inside air humidity sensor 92 with sufficient accuracy.

### OTHER EMBODIMENTS

As mentioned above, although the embodiments of the present disclosure have been described in detail, the present disclosure may further be modified without limitation, as long as the modifications and changes stay within the technical scope of the disclosure.

According to each of the above-mentioned embodiments, it is determined that abnormalities are occurring (i.e., the outside air humidity sensor 91 may possibly be broken) when, in Step S108 or Step S114, predetermined conditions are satisfied. However, a filtering time may be used when performing such a determination. That is, it (i.e., the situation) may be determined as abnormal (i.e., S108/S114 may branch to a YES determination) only when the conditions satisfied state regarding Step S108 or Step S114 continues for equal to or greater than a predetermined filtering time. According to such a determination scheme, even when a momentary noise, e.g., a pulse noise, rides on a signal in the electronic control unit 10, for example, an erroneous determination resulting from the momentary satisfaction of the conditions in Step S108 or Step S114 can be avoided.

Although each of the above-mentioned embodiments is described as the example in which humidity detected by the outside air humidity sensor 91 and the inside air humidity sensor 92 is a relative humidity, the outside/inside air humidity may be an absolute humidity, or the humidity may be measured as correlating physical quantity, such as a voltage and the like correlated with humidity. That is, due to a humidity calculation by using either an analog circuit or a digital circuit in calculating the humidity difference ϕ−ρ with the electronic control unit 10, the voltage corresponding to the inside air humidity ϕ or to the outside air humidity ρ is usable in such calculation.

Although the present disclosure has been fully described in connection with preferred embodiment thereof with reference to the accompanying drawings, it is to be noted that various changes and modifications will become apparent to those skilled in the art, and such changes, modifications, and summarized scheme are to be understood as being within the scope of the present disclosure as defined by appended claims.

What is claimed is:

1. An electronic control unit (ECU) that obtains an outside air humidity detected by an outside air humidity sensor disposed at a position outside a vehicle compartment of a vehicle and an inside air humidity detected by an inside air humidity sensor disposed at a position inside the vehicle compartment, the ECU comprising:
a humidity obtainer obtaining the inside air humidity and the outside air humidity;
a humidity difference calculator calculating a humidity difference between (i) the inside air humidity after a preset amount of humidity adjustment time from a start of a dehumidification of inside of the vehicle compartment and (ii) the outside air humidity; and
a comparator determining that either the outside air humidity sensor or the inside air humidity sensor is broken when the humidity difference is greater than a first threshold (P1).

2. The electronic control unit (ECU) of claim 1, wherein
the outside air humidity sensor is determined as broken when the humidity difference continues to be in a state of greater than the first threshold for at least a preset filtering lime.

3. An electronic control unit (ECU) that obtains an outside air humidity detected by an outside air humidity sensor disposed at a position outside a vehicle compartment of a vehicle and an inside air humidity detected by an inside air humidity sensor disposed at a position inside the vehicle compartment, the ECU comprising:
a humidity obtainer obtaining the inside air humidity and the outside air humidity;
a humidity difference calculator calculating a humidity difference between (i) the inside air humidity after a preset amount of humidity adjustment time from a start of a humidification of inside of the vehicle compartment and (ii) the outside air humidity; and
a comparator determining that either the outside air humidity sensor or the inside air humidity sensor is broken when the humidity difference is smaller than a second threshold.

4. The electronic control unit (ECU) of claim 3, wherein
the outside air humidity sensor is determined as broken when the humidity difference continues to be in a state of smaller than the second threshold for at least a preset filtering time.

5. The electronic control unit (ECU) of claim 1, wherein
the threshold that is compared with the humidity difference is determined based on a measurement error of the inside air humidity and a measurement error of the outside air humidity.

6. The electronic control unit (ECU) of claim 1, wherein
the humidity adjustment time is set to be a longer amount of time when an air circulation mode in the vehicle is set to an outside air introduction mode than when the air circulation mode is set to an inside air recirculation mode.

7. The electronic control unit (ECU) of claim 1, wherein
on condition that the inside air humidity sensor is normal, the outside air humidity sensor is determined as broken.

8. The electronic control unit (ECU) of claim 3, wherein
the threshold that is compared with the humidity difference is determined based on a measurement error of the inside air humidity and a measurement error of the outside air humidity.

9. The electronic control unit (ECU) of claim 3, wherein
the humidity adjustment time is set to be a longer amount of time when an air circulation mode in the vehicle is set to an outside air introduction mode than when the air circulation mode is set to an inside air recirculation mode.

10. The electronic control unit (ECU) of claim 1, wherein
on condition that the inside air humidity sensor is normal, the outside air humidity sensor is determined as broken.
